(19) United States
(12) Patent Application Publication
(10) Pub. No.: US 2026/0067277 A1
(43) Pub. Date: Mar. 5, 2026

(54) IKE-BASED PATH IDENTITY

(71) Applicant: Cisco Technology, Inc., San Jose, CA (US)

(72) Inventors: Xiaorong Wang, Shanghai (CN); Amjad Inamdar, Bangalore (IN); Pan Wu, Shanghai (CN); Lianxiang Wang, Shanghai (CN); Anoop V A, Bangalore (IN); Yajun Chen, Shanghai (CN)

(21) Appl. No.: 19/097,586

(22) Filed: Apr. 1, 2025

(30) Foreign Application Priority Data
Aug. 31, 2024 (IN) 202441065864

(51) Int. Cl. H04L 9/40

(52) U.S. Cl. CPC H04L 63/0876; H04L 63/0435; H04L 63/20

(57) ABSTRACT

The present technology uses the IKE protocol to establish a path identity on both sides of a peer connection. This is achieved by using IKE to exchange local and peer device identifiers along with transport identifiers. IKE then populates the path identity into the IPsec data plane by associating it with the transmit and receive security association databases (IPsec Tx & Rx SA DB). The device's data plane can monitor traffic sent or received through these IPsec SAs by using the path identity information linked with the IPsec SAs. This allows the creation of an application-to-path monitoring record, or matching traffic to the record for purposes such as statistics collection, troubleshooting, and performance evaluation.

### CROSS-REFERENCE TO RELATED APPLICATIONS

The present application claims priority to Indian Provisional Patent Application No. 202441065864, filed on Aug. 31, 2024, the contents of which are hereby incorporated by reference in their entirety.

### TECHNICAL FIELD

The present disclosure relates to network communication, and in particular to determining path identity.

### BACKGROUND

Internet Key Exchange (IKE) based pairwise IPSec virtual private network (VPN) does not have the notion of path identity, especially when there is a network address translation (NAT) in between the peers.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a high-level network architecture in accordance with at least one embodiment of the present technology.

FIG. 2 illustrates a schematic diagram of an IKE protocol exchange in accordance with at least one embodiment of the present technology.

FIG. 3 illustrates a schematic diagram of network architecture used during the determination of path identity during an IKE exchange in accordance with at least one embodiment of the present technology.

FIG. 4 illustrates a routine in accordance with at least one embodiment of the present technology.

FIG. 5 shows an example of a system for implementing certain aspects of the present technology.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

A used herein the term “configured” shall be considered to interchangeably be used to refer to configured and configurable, unless the term “configurable” is explicitly used to distinguish from “configured”. The proper understanding of the term will be apparent to persons of ordinary skill in the art in the context in which the term is used.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### OVERVIEW

Path identity is an important component of visualizing a network path. Path identity allows network administrators to determine which network paths are potentially causing network-wide issues. Path identity can therefore be used to troubleshoot, evaluate the performance of a network or subnetwork, isolate issues that cause effects across the network, and even comply with legal requirements.

IKE does not have the notion of path identity. This is especially true when NAT takes place between a local and peer device. By translating the private IP addresses within a local network to a public IP address before the data exits the network, NAT obscures the internal IP structure and the individual identities of devices on the network. This process not only hides the actual internal IP addresses from external observers but also often results in multiple internal devices sharing a single public IP address. Consequently, external systems or network administrators trying to trace or establish a communication path can only see the public IP, making it difficult to pinpoint which specific device behind the NAT initiated or received the communication. Network administrators are therefore left with few answers when a packet is processed via NAT when traveling from a local device to a peer device.

The present technology uses the IKE protocol to establish a path identity on both sides of a peer connection. This is achieved by using IKE to exchange local and peer device identifiers along with transport identifiers by embedding those identifiers within an IKE payload. IKE can then populate the path identity into an internet protocol security transmit and receive security association database (IPsec Tx & Rx SA DB). This allows the exporting of this data to a controller for review and action by a network administrator.

The presently disclosed embodiments include a method, network device, and computer readable medium that perform the steps: obtaining, at a local device, a local device identification (local device ID) and a local transport identification (local transport ID); embedding the local device ID and the local transport ID into an IKE payload; sending the local device ID and the local transport ID to a peer device by transmitting the IKE payload to the peer device; receiving, by the local device, a peer device ID and a peer transport ID of the peer device; and determining a path identity using the local device ID, the peer device ID, the local transport ID, and the peer transport ID.

In some embodiments, the steps further include populating the path identity to an IPSec Tx and Rx SA DB.

In some embodiments, the steps further include creating an application-path monitoring record based on data stored in the IPSec Tx and Rx SA DB relating to the path identity.

In some embodiments, the local device ID or the peer device ID are at least one member from a group consisting of a media access control (MAC) address, a serial number of the local device ID or the peer device ID, an internet protocol address (IP address), a unique hardware identifier, a system-specific identifier, and a universally unique identifier (UUID).

In some embodiments, the local transport ID or the peer transport ID are at least one member from a group consisting of a unique name or a unique tag associated with an interface that represents a WAN link (i.e. WAN transport).

In some embodiments, the steps further include exporting the application-path monitoring record to a controller.

### Example Embodiments

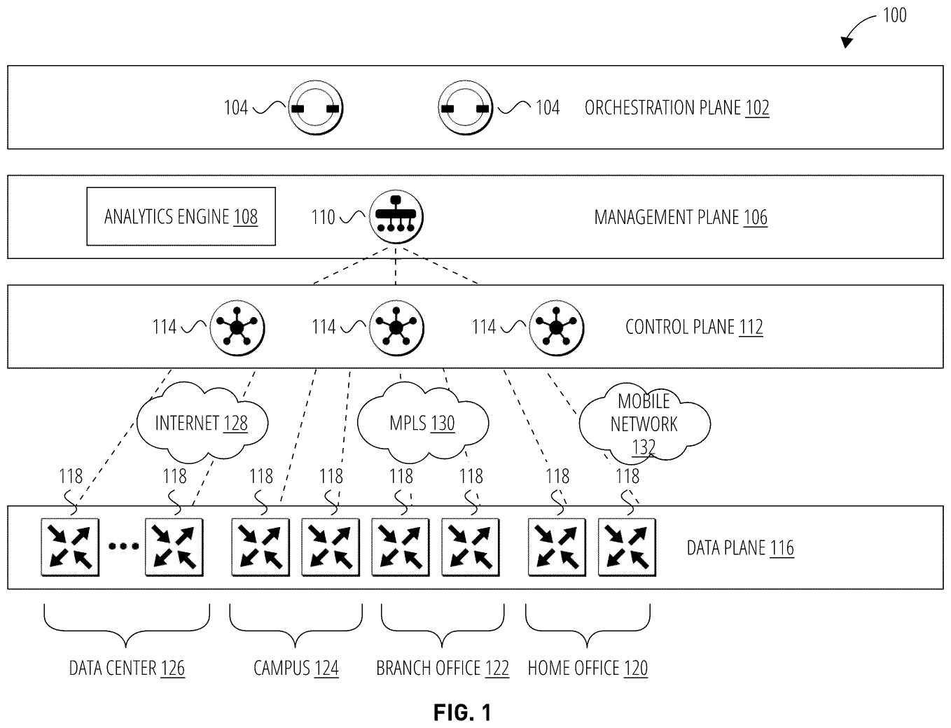

FIG. 1 illustrates an example of a network architecture 100 for implementing aspects of the present technology. An example of an implementation of the network architecture 100 is the Cisco® SD-WAN architecture. However, one of ordinary skill in the art will understand that, for the network architecture 100 and any other system discussed in the present disclosure, there can be additional or fewer component in similar or alternative configurations. The illustrations and examples provided in the present disclosure are for conciseness and clarity. Other embodiments may include different numbers and/or types of elements but one of ordinary skill the art will appreciate that such variations do not depart from the scope of the present disclosure.

In this example, the network architecture 100 can comprise an orchestration plane 102, a management plane 106 with an analytics engine 108 and network management appliance 110, a control plane 112, and a data plane 116. The orchestration plane 102 can assist in the automatic on-boarding of edge network devices 118 (e.g., switches, routers, etc.) in an overlay network. The orchestration plane 102 can include one or more physical or virtual network orchestrator appliances 104. The network orchestrator appliances 104 can perform the initial authentication of the edge network devices 118 and orchestrate connectivity between devices of the control plane 112 and the data plane 116. In some embodiments, the network orchestrator appliances 104 can also enable communication of devices located behind Network Address Translation (NAT). In some embodiments, physical or virtual Cisco® SD-WAN vBond appliances can operate as the network orchestrator appliances 104.

The management plane 106 can be responsible for central configuration and monitoring of a network. The management plane 106 can include one or more physical or virtual network management appliances 110. In some embodiments, the network management appliances 110 can provide centralized management of the network via a graphical user interface to enable a user to monitor, configure, and maintain the edge network devices 118 and links (e.g., internet transport network 128, MPLS network 130, 4G/Mobile network 132) in an underlay and overlay network. The network management appliances 110 can support multi-tenancy and enable centralized management of logically isolated networks associated with different entities (e.g., enterprises, divisions within enterprises, groups within divisions, etc.). Alternatively or in addition, the network management appliances 110 can be a dedicated network management system for a single entity. In some embodiments, physical or virtual Cisco® SD-WAN vManage appliances can operate as the network management appliances 110.

The control plane 112 can build and maintain a network topology and make decisions on where traffic flows. The control plane 112 can include one or more physical or virtual network control appliances 114. The network control appliances 114 can establish secure connections to each edge network device 118 and distribute route and policy information via a control plane protocol (e.g., Overlay Management Protocol (OMP) (discussed in further detail below), Open Shortest Path First (OSPF), Intermediate System to Intermediate System (IS-IS), Border Gateway Protocol (BGP), Protocol-Independent Multicast (PIM), Internet Group Management Protocol (IGMP), Internet Control Message Protocol (ICMP), Address Resolution Protocol (ARP), Bidirectional Forwarding Detection (BFD), Link Aggregation Control Protocol (LACP), etc.). In some embodiments, the network control appliances 114 can operate as route reflectors. The network control appliances 114 can also orchestrate secure connectivity in the data plane 116 between and among the edge network devices 118. For example, in some embodiments, the network control appliances 114 can distribute crypto key information among the edge network devices 118. This can allow the network to support a secure network protocol or application (e.g., Internet Protocol Security (IPSec), Transport Layer Security (TLS), Secure Shell (SSH), etc.) without Internet Key Exchange (IKE) and enable scalability of the network. In some embodiments, physical or virtual Cisco® SD-WAN vSmart controllers can operate as the network control appliances 114.

The data plane 116 can be responsible for forwarding packets based on decisions from the control plane 112. The data plane 116 can include the edge network devices 118, which can be physical or virtual edge network devices. The edge network devices 118 can operate at the edges various network environments of an organization, such as in one or more data centers 126, campus networks 124, branch office networks 122, home office networks 120, and so forth, or in the cloud (e.g., Infrastructure as a Service (IaaS), Platform as a Service (PaaS), SaaS, and other cloud service provider networks). The edge network devices 118 can provide secure data plane connectivity among sites over one or more WAN transports, such as via one or more internet transport networks 128 (e.g., Digital Subscriber Line (DSL), cable, etc.), MPLS networks 130 (or other private packet-switched network (e.g., Metro Ethernet, Frame Relay, Asynchronous Transfer Mode (ATM), etc.), mobile networks 132 (e.g., 3G, 4G/LTE, 5G, etc.), or other WAN technology (e.g., Synchronous Optical Networking (SONET), Synchronous Digital Hierarchy (SDH), Dense Wavelength Division Multiplexing (DWDM), or other fiber-optic technology; leased lines (e.g., T1/E1, T3/E3, etc.); Public Switched Telephone Network (PSTN), Integrated Services Digital Network (ISDN), or other private circuit-switched network; small aperture terminal (VSAT) or other satellite network; etc.). The edge network devices 118 can be responsible for traffic forwarding, security, encryption, quality of service (QoS), and routing (e.g., BGP, OSPF, etc.), among other tasks. In some embodiments, physical or virtual Cisco® SD-WAN vEdge routers can operate as the edge network devices 118.

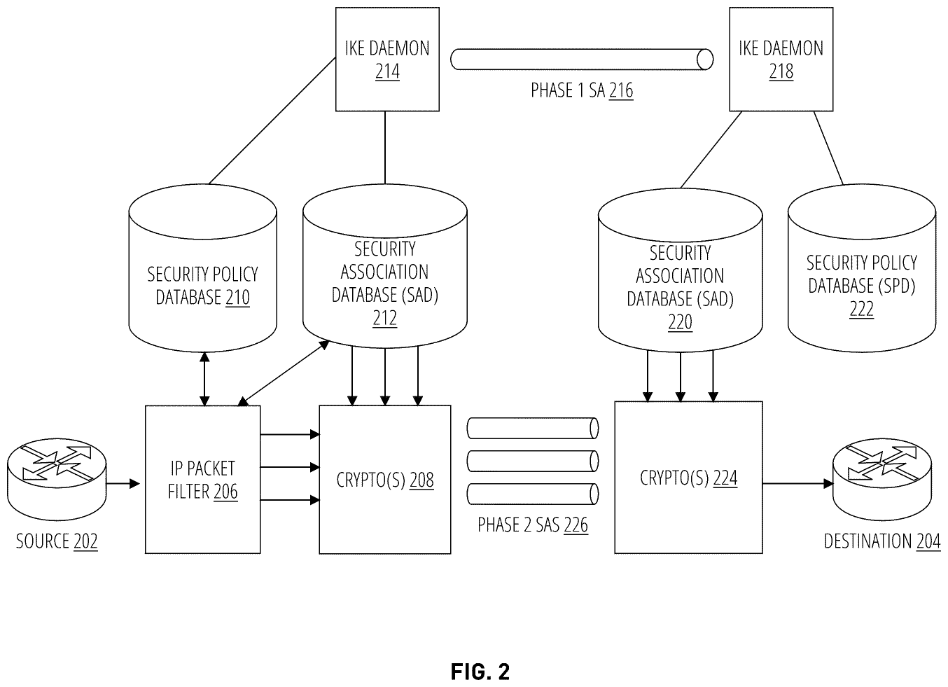

FIG. 2 illustrates a schematic diagram of an IKE protocol exchange in accordance with at least one embodiment of the present technology.

At the inception of the IKE process, a source 202 initiates communication by sending data to an IP packet filter 206. This filter inspects both incoming and outgoing IP packets. It interfaces with a security policy database (SPD 210), which dictates the handling policies for these packets through a pattern matching process. The SPD 210 determines whether packets are to be blocked, allowed through, or subjected to further cryptographic processing based on predefined security rules and criteria. This pattern matching is designed to ensure that only packets conforming to established security policies proceed to the next stages of processing.

Following the initial filtering stage, packets that meet the security criteria are forwarded to cryptographic functions 208. These cryptographic functions 208 are responsible for the encryption and decryption of the packets, underpinned by key materials supplied by the Security Association Database (SAD 212). The SAD 212, which maintains a dynamic and bidirectional link with the IP packet filter 206, stores all active security associations including the cryptographic keys and algorithms. These help the cryptographic functions 208 to securely process the data while maintaining the confidentiality of the packets as they move through the network.

The central management of these security associations is handled by an IKE daemon 214, which orchestrates the overall security policy and key management. The IKE daemon 214 interfaces with both the SPD 210 and the SAD 212 to facilitate dynamic updates and management of security policies and associations. The IKE daemon 214 initiates the negotiation of security associations with an IKE daemon 218 on a peer system via a Phase 1 Security Association 216, establishing a secure and authenticated communication channel. This phase sets the foundation for secure data exchange by authenticating the IKE daemon 214 and the IKE daemon 218 and agreeing on a master key, which is then used to secure further communications.

On the peer side, the IKE daemon 218 engages in similar interactions with its local Security Association Database (SAD 220) and Security Policy Database (SPD 222). The IKE daemon 218 also governs cryptographic functions 224 that manage the encryption and decryption processes for the destination end. The SAD 220 supplies the key material to the cryptographic functions 224, analogous to the role played by SAD 212 on the initiating side. This establishes that the data reaching the destination 204 is processed according to similar stringent security standards as on the initiating side.

Also shown are phase 2 SAs 226 that establish and maintain secure communication channels between the two cryptographic endpoints. The phase 2 SAs 226 help enable the encryption and decryption of packets. Specifically, the phase 2 SAs 226 define the parameters for the necessary security functions, such as the encryption algorithms, keys, and the life span of the keys. They are negotiated after the initial exchange in Phase 1, focusing on securing the actual data transfer between the devices.

SAD 212 and SAD 220 not only provide key materials for current encryption tasks but also handle the lifecycle of these keys, including their renewal and secure deletion. Old or expired keys are systematically removed from the system to prevent their potential misuse in cryptographic attacks. This process of key cleanup and deletion is intended to maintain the security integrity of the communication channel over time.

Furthermore, the IKE protocol uses IKE payloads throughout its phases to exchange information such as key generation algorithms, encryption methods, and identities. These payloads are encapsulated within IKE messages and are used to negotiate the parameters of the security association.

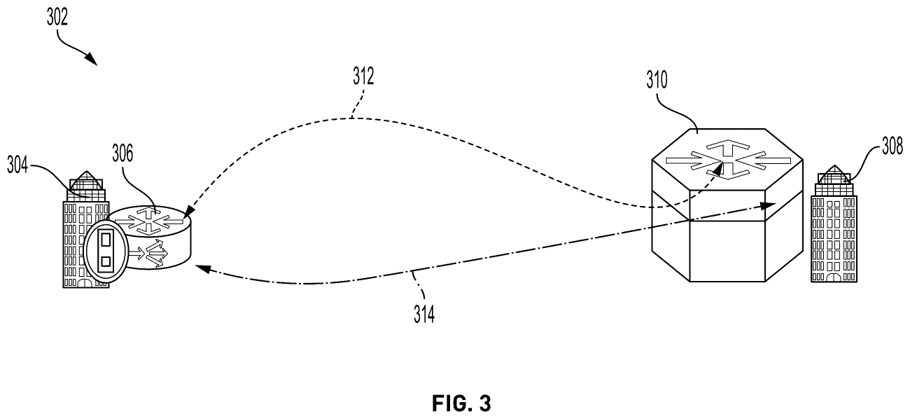

FIG. 3 illustrates a schematic diagram of network architecture used during the determination of path identity during an IKE exchange in accordance with at least one embodiment of the present technology. As shown, network architecture 302 includes a local site 304 with a local network device 306 that can communicate with a peer site 308 with a peer network device 310. For example, the local network device 306 can bidirectionally communicate with the peer network device 310 across a first tunnel 312 or a second tunnel 314.

The IKE exchange can begin by obtaining the IP address of the local network device 306, each of which can be considered the “local IP.” This step can also include obtaining the local transport identification (local transport ID), such as an interface name. The local IP and local transport ID can then be added to the IKE payload, for example by the local network device 306. The payload with other data can then be sent in a data packet to the peer site 308.

The peer network device 310 can then receive the IKE packet and continue the IKE exchange. For example, the peer network device 310 can verify the identity of the local site 304 as communicated in the SA. Upon successful verification, it may proceed to negotiate or establish the necessary security parameters for setting up a secure communication channel. After completing the IKE exchange and establishing the security parameters, the peer network device 310 then transitions to the data-plane phase, where it processes data packets. In this stage, the peer network device 310 applies the negotiated security policies to encrypt and decrypt traffic so as to create a secure transmission.

As part of the data processing sequence, a feature (e.g., application performance monitor (APM) or network wide path insight (NWPI)) leverages the SA to retrieve the identity of the local site 304 or local network device 306. The path between the local site 304 and the peer site 308 can then be built using the local device ID, peer device ID, local transport ID, and peer transport ID that were exchanged during the IKE exchange. The path can then the monitored and statistics recorded for purposes of troubleshooting, issue isolation, performance evaluation, or any other reason. To do this, the data associated with the path, and the path identity itself, can be provided to a network controller and then displayed on a network administrator's user device.

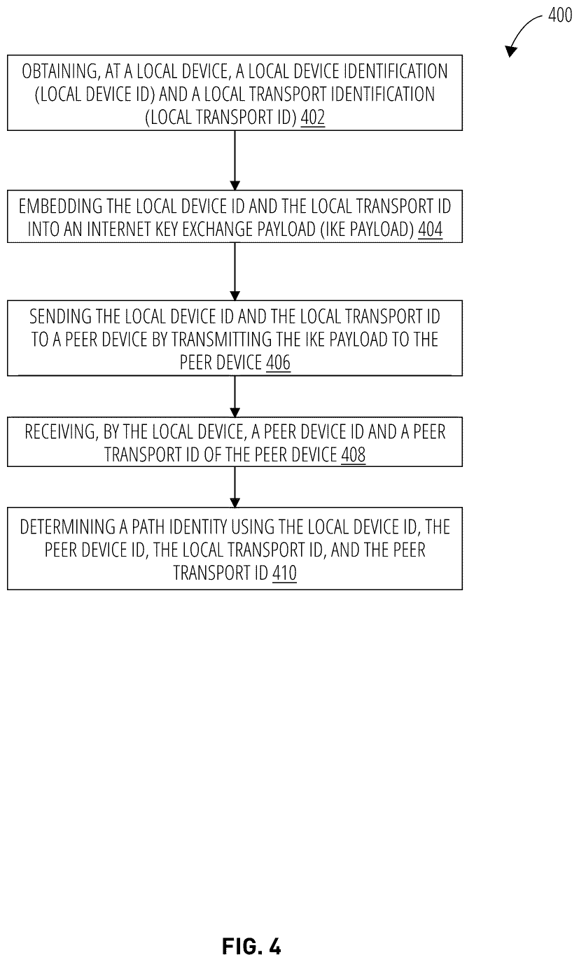

FIG. 4 illustrates an example routine 400 for determining a path identity according to at least one embodiment of the present technology. Although the example routine 400 depicts a particular sequence of operations, the sequence may be altered without departing from the scope of the present disclosure. For example, some of the operations depicted may be performed in parallel or in a different sequence that does not materially affect the function of the routine 400. In other examples, different components of an example device or system that implements the routine 400 may perform functions at substantially the same time or in a specific sequence.

According to some examples, the method includes at block 402 obtaining, at a local device, a local device identification (local device ID) and a local transport identification (local transport ID). For example, the local network device 306 can obtain a local device ID and a local transport ID. The local device ID (and as described later, the peer device ID) can be at least one member from a group consisting of a media access control (MAC) address, a serial number of the local device ID or the peer device ID, an internet protocol address (IP address), a unique hardware identifier, a system-specific identifier, and a universally unique identifier (UUID). The local transport ID (and as described later, the peer transport ID) can be at least one member from a group consisting of a unique name or a unique tag associated with an interface that represents a WAN link (i.e. WAN transport).

The local device ID (and later, the peer device ID) can be obtained in any known manner. For example, the local network device 306 or peer network device 310 may query its hardware configuration to extract a MAC address or may use system tools to generate or retrieve a UUID. Similarly, the local transport ID and the peer transport ID can also be obtained in any known manner. For example, the local network device 306 or peer network device 310 may utilize network management commands or APIs to fetch the unique name or a unique tag associated with an interface that represents a WAN link (i.e. WAN transport). Any other method of obtaining a local device ID, peer device ID, local transport ID, or peer transport ID, can be implemented without departing from the spirit and scope of the present technology.

According to some examples, the method includes embedding the local device ID and the local transport ID into an internet key exchange payload (IKE payload) at block 404. For example, the local network device 306 can embed the local device ID and the local transport ID into an IKE payload. This involves placing the data in predetermined sections of the payload, each designated for specific types of information, which allows each piece of data to be correctly interpreted and utilized according to the IKE negotiation process when the payload is decoded by the receiving device. Any other manner of embedding this data into the payload may be implemented.

According to some examples, the method includes sending the local device ID and the local transport ID to a peer device by transmitting the IKE payload to the peer device at block 406. For example, the local network device 306 can send the local device ID and the local transport ID to a peer device by transmitting the IKE payload to the peer device. The peer device can be, for example, the peer network device 310 from FIG. 3. The payload will, of course, be part of a larger data packet with other data associated with it for proper transmission and processing.

As one example, the packet may be communicated via the IKE control plane. For example, the packet can be encapsulated and labeled with appropriate headers before transmission so that it adheres to the protocols of IKE phase communications. This encapsulation can include the use of security parameters that were previously negotiated to help in maintaining the confidentiality and integrity of the data as it traverses the network.

According to some examples, the method includes receiving, by the local device, a peer device ID and a peer transport ID of the peer device at block 408. For example, the local network device 306 of FIG. 3 can receive the peer device ID and the peer transport ID of the peer device at block 408. The peer device ID and peer transport ID can be sent from, for example, the peer network device 310 and can be embedded within a packet that is transported via the IKE exchange process.

According to some examples, the method includes determining a path identity using the local device ID, the peer device ID, the local transport ID, and the peer transport ID at block 410. For example, the local network device 306 or the peer network device 310 can determine the path identity using the local device ID, the peer device ID, the local transport ID, and the peer transport ID at block 410. Similarly, local and peer transport IDs can be used to identify the specific sessions or streams of communication between these endpoints. By assessing this combination of device and transport IDs, a network device can accurately map the data path, manage routing decisions, and allow data packets to follow the correct and secure route tailored to the specific characteristics of the network session involved.

Determining path identity can be incredibly useful for network operation. To that end, the method can further include populating the path identity to an internet protocol security transmission and reception security association database (IPSec Tx and Rx SA DB). An IPSec Tx and Rx SA DB is a repository where SAs for both transmitting (Tx) and receiving (Rx) are stored and managed within an IPSec security framework. This database keeps track of the cryptographic parameters such as keys, algorithms, and other settings used to encrypt and decrypt the IP packets. Each SA in the database corresponds to a specific secure connection and contains necessary details for the IPsec engine to process the packets accordingly so that data transmitted over the network is protected from unauthorized access and tampering. Here, the method further utilizes this database by storing the path identity therein for future retrieval to create an application-path monitoring record that can be exported to a controller for application-path monitoring, troubleshooting and performance measurements.

As discussed earlier, determining path identity is helpful for network administrators to effectively manage their network. For example, path identity can be used for troubleshooting, performance evaluation, isolation of issues, and compliance with legal requests, among others. For this reason, it is helpful for the path identity to be provided to the network administrator with necessary statistical data provided with it. The method can therefore further include creating an application-path monitoring record based on data stored in the IPSec Tx and Rx SA DB relating to the path identity; and exporting the application-path monitoring record to a controller.

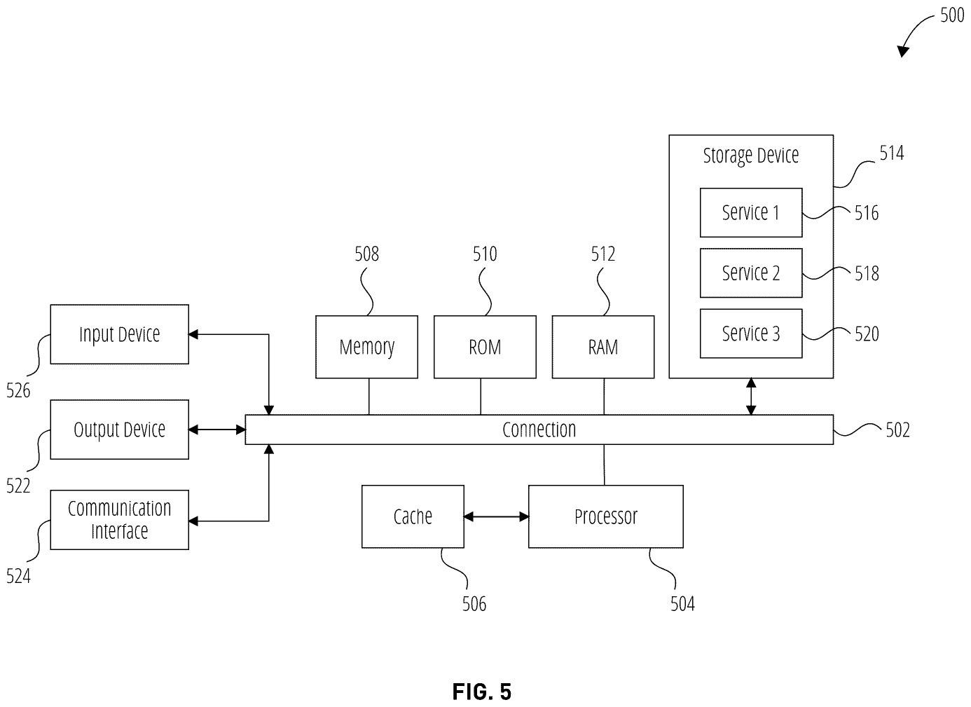

FIG. 5 shows an example of computing system 500, which can be for example any computing device making up a controller, for example a controller of an SDWAN network, or any component thereof in which the components of the system are in communication with each other using connection 502. Connection 502 can be a physical connection via a bus, or a direct connection into processor 504, such as in a chipset architecture. Connection 502 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 500 includes at least one processing unit (CPU or processor) 504 and connection 502 that couples various system components including system memory 508, such as read-only memory (ROM) 510 and random access memory (RAM) 512 to processor 504. Computing system 500 can include a cache of high-speed memory 506 connected directly with, in close proximity to, or integrated as part of processor 504.

Processor 504 can include any general purpose processor and a hardware service or software service, such as services 516, 518, and 520 stored in storage device 514, configured to control processor 504 as well as a special-purpose processor where software instructions are incorporated into the actual processor design. Processor 504 may essentially be a completely self-contained computing system, containing multiple cores or processors, a bus, memory controller, cache, etc. A multi-core processor may be symmetric or asymmetric.

To enable user interaction, computing system 500 includes an input device 526, which can represent any number of input mechanisms, such as a microphone for speech, a touch-sensitive screen for gesture or graphical input, keyboard, mouse, motion input, speech, etc. Computing system 500 can also include output device 522, which can be one or more of a number of output mechanisms known to those of skill in the art. In some instances, multimodal systems can enable a user to provide multiple types of input/output to communicate with computing system 500. Computing system 500 can include communication interface 524, which can generally govern and manage the user input and system output. There is no restriction on operating on any particular hardware arrangement, and therefore the basic features here may easily be substituted for improved hardware or firmware arrangements as they are developed.

Storage device 514 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 514 can include software services, servers, services, etc., that when the code that defines such software is executed by the processor 504, it causes the system to perform a function. In some embodiments, a hardware service that performs a particular function can include the software component stored in a computer-readable medium in connection with the necessary hardware components, such as processor 504, connection 502, output device 522, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.
Aspect 1. A method comprising obtaining, at a local device, a local device identification (local device ID) and a local transport identification (local transport ID); embedding the local device ID and the local transport ID into an internet key exchange payload (IKE payload); sending the local device ID and the local transport ID to a peer device by transmitting the IKE payload to the peer device; receiving, by the local device, a peer device ID and a peer transport ID of the peer device; and determining a path identity using the local device ID, the peer device ID, the local transport ID, and the peer transport ID.
Aspect 2. The method of Aspect 1, further comprising populating the path identity to an internet protocol security transmission and reception security association database (IPSec Tx and Rx SA DB).
Aspect 3. The method of Aspect 2, further comprising creating an application-path monitoring record based on data stored in the IPSec Tx and Rx SA DB relating to the path identity.
Aspect 4. The method of Aspect 3, wherein the application-path monitoring record enables application-path monitoring, troubleshooting, and/or performance measurement by a network administrator.
Aspect 5. The method of Aspect 1, wherein the local device ID or the peer device ID are at least one member from a group consisting of a media access control (MAC) address, a serial number of the local device ID or the peer device ID, an internet protocol address (IP address), a unique hardware identifier, a system-specific identifier, and a universally unique identifier (UUID).
Aspect 6. The method of Aspect 1, wherein the local transport ID or the peer transport ID are at least one member from a group consisting of a unique name or a unique tag associated with an interface that represents a WAN link.
Aspect 7. The method of Aspect 3, further comprising exporting the application-path monitoring record to a controller.
Aspect 8. A network device comprising a storage configured to store instructions; and at least one processor configured to execute the instructions and cause the at least one processor to obtain, at a local device, a local device identification (local device ID) and a local transport identification (local transport ID); embed the local device ID and the local transport ID into an internet key exchange payload (IKE payload); send the local device ID and the local transport ID to a peer device by transmitting the IKE payload to the peer device; receive, by the local device, a peer device ID and a peer transport ID of the peer device; and determine a path identity using the local device ID, the peer device ID, the local transport ID, and the peer transport ID.
Aspect 9. The network device of Aspect 8, wherein the at least one processor is configured to execute the instructions and further cause the at least one processor to populate the path identity to an internet protocol security transmission and reception security association database (IPSec Tx and Rx SA DB).
Aspect 10. The network device of Aspect 9, wherein the at least one processor is configured to execute the instructions and further cause the at least one processor to create an application-path monitoring record based on data stored in the IPSec Tx and Rx SA DB relating to the path identity.
Aspect 11. The network device of Aspect 10, wherein the application-path monitoring record enables application-path monitoring, troubleshooting, and/or performance measurement by a network administrator.
Aspect 12. The network device of Aspect 8, wherein the local device ID or the peer device ID are at least one member from a group consisting of a media access control (MAC) address, a serial number of the local device ID or the peer device ID, an internet protocol address (IP address), a unique hardware identifier, a system-specific identifier, and a universally unique identifier (UUID).
Aspect 13. The network device of Aspect 8, wherein the local transport ID or the peer transport ID are at least one member from a group consisting of a unique name or a unique tag associated with an interface that represents a WAN link.
Aspect 14. The network device of Aspect 10, wherein the at least one processor is configured to execute the instructions and further cause the at least one processor to export the application-path monitoring record to a controller.
Aspect 15. A non-transitory computer-readable storage medium including instructions that, when executed by at least one processor, cause the at least one processor to obtain, at a local device, a local device identification (local device ID) and a local transport identification (local transport ID); embed the local device ID and the local transport ID into an internet key exchange payload (IKE payload); send the local device ID and the local transport ID to a peer device by transmitting the IKE payload to the peer device; receive, by the local device, a peer device ID and a peer transport ID of the peer device; and determine a path identity using the local device ID, the peer device ID, the local transport ID, and the peer transport ID.
Aspect 16. The non-transitory computer-readable storage medium of Aspect 15, wherein the at least one processor is configured to execute the instructions and further cause the at least one processor to populate the path identity to an internet protocol security transmission and reception security association database (IPSec Tx and Rx SA DB).
Aspect 17. The non-transitory computer-readable storage medium of Aspect 16, wherein the at least one processor is configured to execute the instructions and further cause the at least one processor to create an application-path monitoring record based on data stored in the IPSec Tx and Rx SA DB relating to the path identity.
Aspect 18. The non-transitory computer-readable storage medium of Aspect 17, wherein the application-path monitoring record enables application-path monitoring, troubleshooting, and/or performance measurement by a network administrator.
Aspect 19. The non-transitory computer-readable storage medium of Aspect 15, wherein the local device ID or the peer device ID are at least one member from a group consisting of a media access control (MAC) address, a serial number of the local device ID or the peer device ID, an internet protocol address (IP address), a unique hardware identifier, a system-specific identifier, and a universally unique identifier (UUID).
Aspect 20. The non-transitory computer-readable storage medium of Aspect 15, wherein the local transport ID or the peer transport ID are at least one member from a group consisting of a unique name or a unique tag associated with an interface that represents a WAN link.

What is claimed is:

1. A method comprising:
obtaining, at a local device, a local device identification (local device ID) and a local transport identification (local transport ID);
embedding the local device ID and the local transport ID into an internet key exchange payload (IKE payload);
sending the local device ID and the local transport ID to a peer device by transmitting the IKE payload to the peer device;
receiving, by the local device, a peer device ID and a peer transport ID of the peer device; and
determining a path identity using the local device ID, the peer device ID, the local transport ID, and the peer transport ID.

2. The method of claim 1, further comprising populating the path identity to an internet protocol security transmission and reception security association database (IPSec Tx and Rx SA DB).

3. The method of claim 2, further comprising creating an application-path monitoring record based on data stored in the IPSec Tx and Rx SA DB relating to the path identity.

4. The method of claim 3, wherein the application-path monitoring record enables application-path monitoring, troubleshooting, and/or performance measurement by a network administrator.

5. The method of claim 1, wherein the local device ID or the peer device ID are at least one member from a group consisting of a media access control (MAC) address, a serial number of the local device ID or the peer device ID, an internet protocol address (IP address), a unique hardware identifier, a system-specific identifier, and a universally unique identifier (UUID).

6. The method of claim 1, wherein the local transport ID or the peer transport ID are at least one member from a group consisting of a unique name or a unique tag associated with an interface that represents a WAN link.

7. The method of claim 3, further comprising exporting the application-path monitoring record to a controller.

8. A network device comprising:
a storage configured to store instructions; and
at least one processor configured to execute the instructions and cause the at least one processor to:
obtain, at a local device, a local device identification (local device ID) and a local transport identification (local transport ID);
embed the local device ID and the local transport ID into an internet key exchange payload (IKE payload);
send the local device ID and the local transport ID to a peer device by transmitting the IKE payload to the peer device;
receive, by the local device, a peer device ID and a peer transport ID of the peer device; and
determine a path identity using the local device ID, the peer device ID, the local transport ID, and the peer transport ID.

9. The network device of claim 8, wherein the at least one processor is configured to execute the instructions and further cause the at least one processor to populate the path identity to an internet protocol security transmission and reception security association database (IPSec Tx and Rx SA DB).

10. The network device of claim 9, wherein the at least one processor is configured to execute the instructions and further cause the at least one processor to create an application-path monitoring record based on data stored in the IPSec Tx and Rx SA DB relating to the path identity.

11. The network device of claim 10, wherein the application-path monitoring record enables application-path monitoring, troubleshooting, and/or performance measurement by a network administrator.

12. The network device of claim 8, wherein the local device ID or the peer device ID are at least one member from a group consisting of a media access control (MAC) address, a serial number of the local device ID or the peer device ID, an internet protocol address (IP address), a unique hardware identifier, a system-specific identifier, and a universally unique identifier (UUID).

13. The network device of claim 8, wherein the local transport ID or the peer transport ID are at least one member from a group consisting of a unique name or a unique tag associated with an interface that represents a WAN link.

14. The network device of claim 10, wherein the at least one processor is configured to execute the instructions and further cause the at least one processor to export the application-path monitoring record to a controller.

15. A non-transitory computer-readable storage medium including instructions that, when executed by at least one processor, cause the at least one processor to:
obtain, at a local device, a local device identification (local device ID) and a local transport identification (local transport ID);
embed the local device ID and the local transport ID into an internet key exchange payload (IKE payload);
send the local device ID and the local transport ID to a peer device by transmitting the IKE payload to the peer device;
receive, by the local device, a peer device ID and a peer transport ID of the peer device; and
determine a path identity using the local device ID, the peer device ID, the local transport ID, and the peer transport ID.

16. The non-transitory computer-readable storage medium of claim 15, wherein the at least one processor is configured to execute the instructions and further cause the at least one processor to populate the path identity to an internet protocol security transmission and reception security association database (IPSec Tx and Rx SA DB).

17. The non-transitory computer-readable storage medium of claim 16, wherein the at least one processor is configured to execute the instructions and further cause the at least one processor to create an application-path monitoring record based on data stored in the IPSec Tx and Rx SA DB relating to the path identity.

18. The non-transitory computer-readable storage medium of claim 17, wherein the application-path monitoring record enables application-path monitoring, troubleshooting, and/or performance measurement by a network administrator.

19. The non-transitory computer-readable storage medium of claim 15, wherein the local device ID or the peer device ID are at least one member from a group consisting of a media access control (MAC) address, a serial number of the local device ID or the peer device ID, an internet protocol address (IP address), a unique hardware identifier, a system-specific identifier, and a universally unique identifier (UUID).

20. The non-transitory computer-readable storage medium of claim 15, wherein the local transport ID or the peer transport ID are at least one member from a group consisting of a unique name or a unique tag associated with an interface that represents a WAN link.
